(19) United States
(12) Patent Application Publication
(10) Pub. No.: US 2003/0061269 A1
(43) Pub. Date: Mar. 27, 2003

(54) Data flow engine

(75) Inventors: Michael W. Hathaway, Austin, TX (US); Gary Benton McMillian, Austin, TX (US)

Correspondence Address: AKIN, GUMP, STRAUSS, HAUER & FELD, L.L.P., 300 WEST 6TH STREET, SUITE 2100, AUSTIN, TX, 78701, US

(73) Assignee: Flow Engines, Inc., Austin, TX (US)

(21) Appl. No.: 09/953,806

(22) Filed: Sep. 17, 2001

(51) Int. Cl. G06F 15/16; G06F 9/00

(52) U.S. Cl. 709/202; 709/100

(57) ABSTRACT

A Data Flow Engine. The present invention presents, for the first time, a solution that removes a processor out of the traditionally known data plane. The use of a Flow Engine operates on data using object-oriented processing. The present invention also provides for a solution that may significantly reduce the requirements of very high bus widths to accommodate large data throughputs. The data (or portions of the data) may be stored in a data path and information is passed to a control plane to separate all or some of the memory management functionality from the processor. The present invention is scalable, enabling operation of any number of Flow Engines in a variety of configurations including embodiments that employ one or both of in-stream and out-stream processors and embodiments that employ daisy-chained control using processors.

### BACKGROUND

1. Technical Field

The invention relates generally to data processing; and, more particularly, it relates to a data Flow Engine that allows significantly higher data throughput in a data processing system.

2. Related Art

Conventional processing systems commonly require and employ very wide bus widths in order to accommodate the large amount of memory management that they must perform in data processing. There is commonly a dichotomy of a data plane and a control plane in the architecture of most prior art systems. All of the data is typically passed to and from the processor (or to and from memory that is used by the new processor) when any processing on the data must be performed. In conventional systems, all of the buffer management functionality is typically performed in a processor that is contained within a data plane.

In the prior art, processors are used in network communications equipment to provide packet classification, forwarding, scheduling and queuing, message segmentation and reassembly, security and other protocol processing functions. The conventional network processor operates on data flowing between the network interface, which may be a SONET framer, Ethernet media access controller (MAC), Fibre Channel MAC or other device, and a switch fabric, host processor, storage controller or other interface. An example of such a typical prior art architecture is an in-stream network processor 120 that is shown and described below in the FIG. 1.

FIG. 1 shows a high-level system diagram illustrating an embodiment of a prior art processing system 100. This architecture illustrates the traditional dichotomy of a data plane (horizontal) and a control plane (vertical). A device 110 performs network interfacing using network interface circuitry 112. A device 130 performs fabric/host/storage controller interfacing using a fabric/host/storage controller interface circuitry 132. Between these two devices lies the in-stream processor 120. The in-stream processor 120 is operable to perform buffer management functionality 122. The in-stream processor 120 also uses an external memory 140 to which data is written, and from which data is read, during receipt and transmission of data from the devices 110 and 130. The port(s) that communicatively couple(s) the device 110 to the in-stream processor 120 may be uni-directional or bi-directional; similarly, the port(s) that communicatively couple(s) the device 130 to the in-stream processor 120 may be uni-directional or bi-directional.

The port that communicatively couples the in-stream processor 120 to the external memory 140 is bi-directional. This port inherently must be able to accommodate a large amount of data being passed through it; therefore, the bus width here is generally very wide. Typically, the entirety of the data that is received by the in-stream processor 120 from either of the devices 110 or 130 will be passed to the external memory 140. Then, whenever any network processing must be performed on the data using the in-stream processor 120, that entire portion of data must be passed back from memory 140 to the in-stream processor 120 to perform this processing.

This prior art process is amenable to data throughput rates that are relatively low. However, as the requirements of data throughput and data rates continue to increase (radically at times), the conventional methods of performing network processing will fail to serve these increasing needs adequately. For example, as the requirements of higher bit rates, wider bus widths, etc. continue to increase, the conventional systems will continue to fail to meet these needs.

In this implementation, all data flows through the processor. The data is buffered in the processor or in an attached memory. The processor manages all information stored in the buffer memory. The system may implement uni-directional or bi-directional information flow through the processor, depending on interface bandwidth or processor performance requirements.

As mentioned above, devices that operate in-line with the information flow (data flow) are in the “data plane” and are designed to accommodate the full rate of information flowing through the system (operate at “line speed”). Devices that control the operation of the devices in the data plane or operate on a subset of the information flowing through the data plane are in the “control plane” of the system.

Data buffers are used to buffer incoming or outgoing information. Buffering is commonly used to match input and output port data rates. If the output port is unavailable, then incoming data is buffered until the output port is again available for transmission or a flow control mechanism halts the incoming data. Buffering is also used for message segmentation and reassembly, encryption and decryption, traffic engineering (queuing), etc. In general, more complex functions operating on larger data sets generally require larger buffers.

Networks commonly use Asynchronous Transfer Mode (ATM) cells or Internet Protocol (IP) packets to transfer information over communications links. A standard packet includes a payload plus a header. The header commonly contains routing and other information about the packet. Some network functions process the information contained in the header and “pass along” the payload. Other network functions also process the information contained in the payload.

Storage systems commonly use Small Computer Systems Interface (SCSI) protocols to transfer commands and blocks of data over communications links between storage devices and servers. SCSI commands and data may be transferred over networks encapsulated in packets.

Multiple processor operations on information stored in buffers typically increase memory bandwidth requirements several-fold over the communications line speed in many networking applications. For example, a simple buffering operation that temporarily stores incoming information before passing it to the output requires a single write to memory and a single read from memory for each packet. If the packet must be processed through multiple levels of protocols (e.g. a message is reassembled from multiple packets), then each packet may require multiple reads from and writes to memory, causing a corresponding increase in memory bandwidth requirements.

Further limitations and disadvantages of conventional and traditional systems will become apparent to one of skill in the art through comparison of such systems with the invention as set forth in the remainder of the present application with reference to the drawings.

### SUMMARY OF THE INVENTION

In various embodiments of the present invention, one or more Flow Engines is/are communicatively coupled to one or more processors. The Flow Engine is operable to store data in the data path and to pass off selected portions of data to the control plane. The selected portion of an object may very well be the entirety of the data in certain embodiments. In others, the selected portion of an object may be a particular bit, particular bits, a particular byte, and/or particular bytes. In some embodiments of the invention, the selected portion may be a header. The Flow Engine also enables separation of buffer and memory management functions from the processor. In contradistinction to prior art systems where the processor was coupled in the data plane, the present invention provides for a solution where the throughput of data in the system is maximized by the efficiency offered by the Flow Engine.

The Flow Engine enables the removal of the processor from this data plane, thereby enabling a much larger throughput than prior art systems. Thus one aspect of the Data Flow Engine of the present invention is improved data throughput. Variations of embodiments that employ a Flow Engine are also easily scalable. The scalability of the various Flow Engine designs enables multiple Flow Engines and/or multiple in-stream and out-stream processors to be implemented. It is again noted that the Flow Engine may also be implemented into systems that were designed to employ a processor in the data path; thus, the Flow Engine offers backward compatibility.

This summary of the invention captures some, but not all, of the various aspects of the present invention. The claims are directed to some of the various other embodiments of the subject matter towards which the present invention is directed. In addition, other aspects, advantages and novel features of the invention will become apparent from the following detailed description of the invention when considered in conjunction with the accompanying drawings.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a prior art processing system.

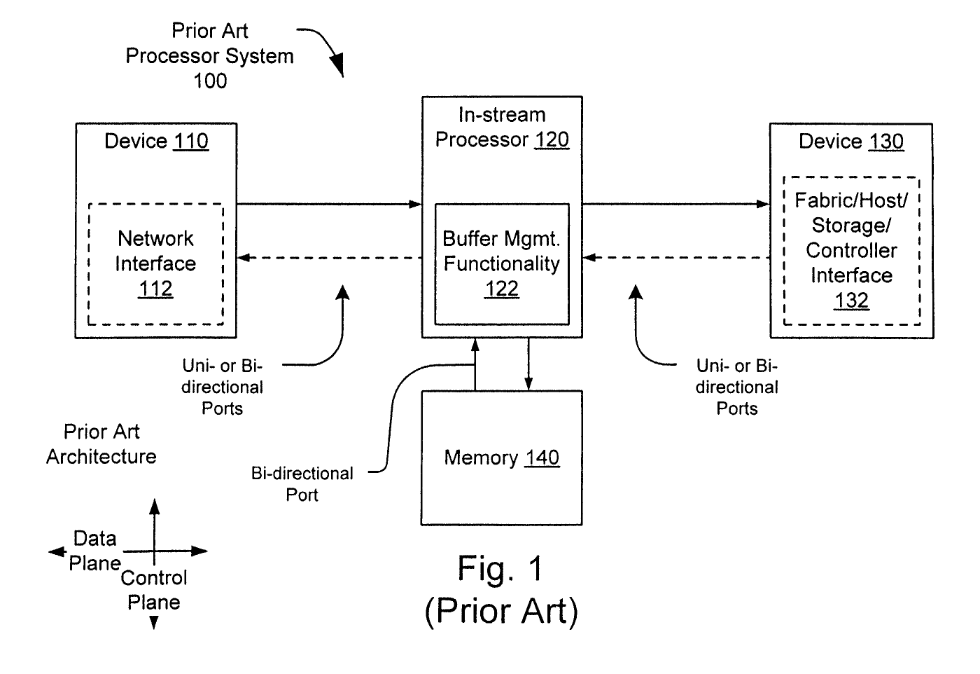

FIG. 2 is a system diagram illustrating an embodiment of a Flow Engine system that is built in accordance with certain aspects of the invention.

FIG. 3 is a system diagram illustrating another embodiment of a Flow Engine system that is built in accordance with certain aspects of the invention.

FIG. 4 is a system diagram illustrating another embodiment of a Flow Engine system that is built in accordance with certain aspects of the invention.

FIG. 5 is a system diagram illustrating another embodiment of a Flow Engine system that is built in accordance with certain aspects of the invention.

FIG. 6 is a system diagram illustrating another embodiment of a Flow Engine system that is built in accordance with certain aspects of the invention.

FIG. 7 is a system diagram illustrating another embodiment of a Flow Engine system that is built in accordance with certain aspects of the invention.

FIG. 8 is a system diagram illustrating another embodiment of a Flow Engine system that is built in accordance with certain aspects of the invention.

FIG. 9 is a system diagram illustrating another embodiment of a Flow Engine system that is built in accordance with certain aspects of the invention.

FIG. 10 is a system diagram illustrating another embodiment of a Flow Engine system that is built in accordance with certain aspects of the invention.

FIG. 11 is a system diagram illustrating another embodiment of a Flow Engine system that is built in accordance with certain aspects of the invention.

FIG. 12 is a functional block diagram illustrating an embodiment of Flow Engine functionality that is performed in accordance with certain aspects of the invention.

FIG. 13 is a functional block diagram illustrating an embodiment of Flow Engine memory allocation that is performed in accordance with certain aspects of the invention.

FIG. 14 is a system diagram illustrating an embodiment of a Flow Engine circular buffer that is built in accordance with certain aspects of the invention.

FIG. 15 is a functional block diagram illustrating an embodiment of Flow Engine operation that is performed in accordance with certain aspects of the invention.

FIG. 16 is a functional block diagram illustrating another embodiment of Flow Engine operation that is performed in accordance with certain aspects of the invention.

FIG. 17 is a functional block diagram illustrating an embodiment of a Flow Engine input processing method that is performed in accordance with certain aspects of the invention.

FIG. 18 is a functional block diagram illustrating an embodiment of a Flow Engine output processing method that is performed in accordance with certain aspects of the invention.

FIG. 19 is a functional block diagram illustrating another embodiment of a Flow Engine input processing method that is performed in accordance with certain aspects of the invention.

FIG. 20 is a functional block diagram illustrating another embodiment of a Flow Engine output processing method that is performed in accordance with certain aspects of the invention.

FIG. 21 is a functional block diagram illustrating another embodiment of a Flow Engine object parsing and Processor interfacing method 2100 that is performed in accordance with certain aspects of the invention.

FIG. 22 is a functional block diagram illustrating another embodiment of a Flow Engine object assembly and Processor interfacing method 2200 that is performed in accordance with certain aspects of the invention.

### DETAILED DESCRIPTION OF THE INVENTION

A Flow Engine, as designed in accordance with various aspects of the present invention, provides intelligent, object-addressable storage of high-speed data and significantly reduces the interface bandwidth requirements of the associated processor. The exact configuration of a flow engine may be varied to meet the specific requirements of the various system embodiments and architectures described hereinbelow.

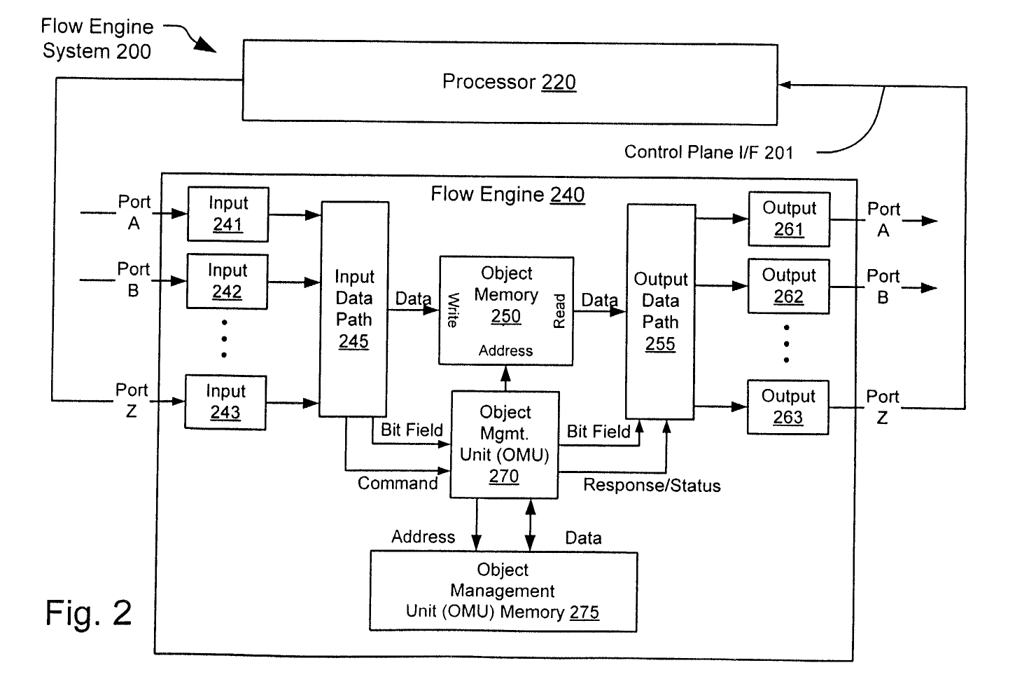

An illustrative example of the operable components of a Flow Engine is shown generally in FIG. 2, which will be discussed in greater detail below in connection with specific aspects of the Flow Engine architecture of the present invention. In the embodiment shown in FIG. 2, the Flow Engine system 200 is operable to accept configuration and operation commands from a Processor and may modify the content or format of the object or attach a label or tag to the object.

FIG. 2 shows a Flow Engine 240 communicatively coupled to a Processor 220. The Flow Engine 240 may extract a bit (byte) field or multiple bit (byte) fields from an object and transmit the extracted data to the Processor 220 for processing. The Flow Engine 240 may accept a bit (byte) field or bit (byte) fields from the Processor 220 for insertion in the object or overlay on the object. The embodiment shown in the FIG. 2 includes an indefinite number of ports (A, B, . . . , and Z) and even additional ports may be added to provide expandability. If desired, some of the ports may be designated as data plane ports and other ports may be designated as control plane ports. For example, the port A and the port B may be designated as data plane ports, and the port Z may be designated as a control plane port that is used to communicatively couple to the Processor 220.

A number of inputs 241, 242, . . . , and 243 provide data to an input data path 245. This data is then written to an object memory 250. The object memory 250 may be implemented as a packet memory in alternative embodiments. The object memory 250 is communicatively coupled to an object management unit (OMU) 270. One or more bit fields and one or more commands are passed to the OMU 270. Addressing is passed from the OMU 270 to the object memory 250.

The OMU 270 employs an OMU memory 275. Addressing is passed to the OMU memory 275 and data is passed in a bi-directional manner to and from the OMU memory 275. The OMU 270 provides a bit (byte) field and response/status information to an output data path 255 that receives data that is read from the object memory 250. The output data path 255 may be partitioned into an output 261 via a port A, an output 262 via a port B, . . . , and an output port 263 via a port Z.

The Controller or Processor 220 sends commands and data to the Flow Engine 240 through the control plane interface using techniques understood by those skilled in the art. The Flow Engine 240 sends responses and data to the Controller or Processor 220 through the control plane interface. The data plane encompasses a high-speed input port, input data path, packet memory, output data path, and output port. The operation of the data plane is managed by the Object Management Unit (OMU) 270, which controls the storage and retrieval of objects in memory and configuration and operation of the input and output data paths.

The OMU 270 provides pointers (addresses) to the object memory 250 for storage of objects received from the data plane and processed by the input data path. The OMU 270 provides pointers (addresses) to the object 250 memory for retrieval of objects for processing by the output data path and transmission through the data plane output path 255.

The OMU 270 receives object bit fields extracted by the input data path 245 and/or other data, formats it and transmits it to the Processor 220 through the control plane interface (shown in this embodiment as via the port Z). The OMU 270 also receives commands and data from the Processor 220 through the control plane interface. The OMU 270 forwards the bit (byte) fields and/or other information to the output data path 255 for application to the outgoing object specified by the command. The OMU 270 provides a response or status (e.g. packet transmission acknowledgement) to a command received from the Processor 220. The output data path 255 may be configured to automatically operate on objects without need for bit fields or other data or information from the control plane.

In addition to object bit field extraction and insertion in the input and output data paths, other data path functions may include label or tag attachment (insertion) or detachment (extraction), or error checking and correction (ECC) of object (packet header and/or payload) or memory contents. The OMU 270 may receive some or all object data from the control plane input, and may transmit some or all object data through the control plane output.

In the abstract, information is processed at the object level. The object may be comprised of a packet header and packet payload, storage command and data block, Sockets data or combination thereof.

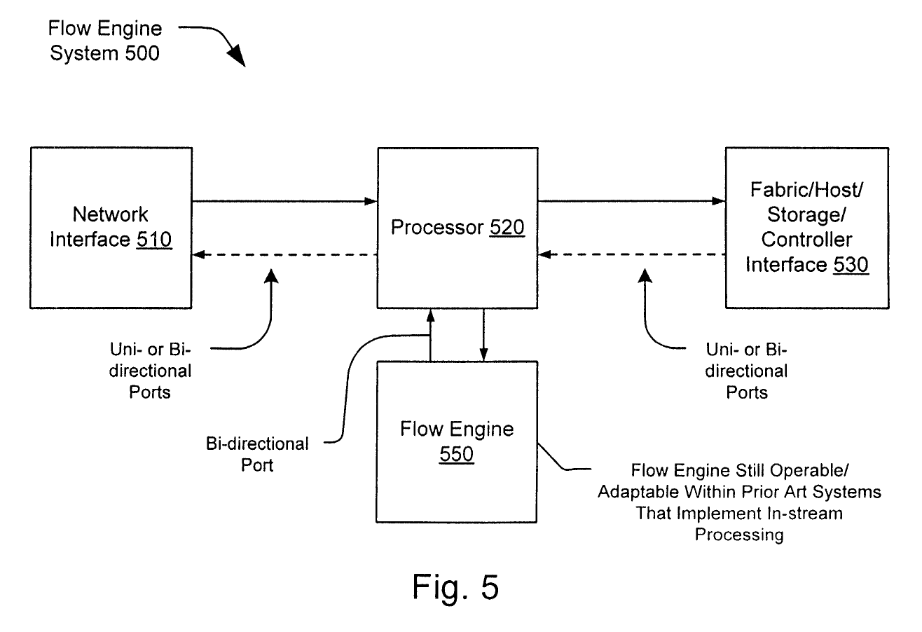

As is described below in the embodiment of the FIG. 5, a Flow Engine can be operated as an intelligent object memory capable of receiving and sending packets from and to an in-stream Processor, such as the Processor 520 in FIG. 5. A Flow Engine provides object storage and buffer management functions through the control plane interface.

In general, an OMU (such as the OMU 270) provides a object-addressable interface to the Controller or Processor via the control plane interface. The OMU manages system resources, which include segments of memory (a single row/page or multiple rows/pages) available for storage of incoming objects. Each memory segment contains a complete object, or a portion of an object.

Objects that are larger than a single row may be mapped to contiguous rows in memory or non-contiguous rows in memory. If mapped to non-contiguous rows in memory, then an ordered list of row pointers is placed in memory to identify the set of rows containing the object. If mapped to contiguous rows in memory, then a single pointer is placed in memory identifying the location of the rows containing the object.

Packets are variable in size, but tend to be either minimum size packets, corresponding to TCP acknowledgements, or maximum size packets, corresponding to a standard MTU of approximately 1500 bytes. However, some packets lie between the minimum and maximum size. Some systems also support “Jumbo” size packets of approximately 9000 bytes.

In this embodiment, buffer memory is divided into one or more partitions, with each partition containing objects of fixed size (a multiple of the base block size, e.g. 64 bytes). For example, a memory partition may be allocated for 64 byte or lesser size objects and a second partition allocated for 64×24=1536 byte or lesser size objects.

Within each partition, a unique address or reference pointer is used to address a particular object entry. For example, a 20 bit pointer provides 2ˆ 20 unique object entries. The memory required to hold 2ˆ 20 64 byte objects is 64×2ˆ 20=2ˆ 26 bytes (64 MB). The memory required to hold 2ˆ 20 1536 byte objects is 3×2ˆ 29 bytes (1.5 GB).

Alternatively, for a fixed buffer size of 2ˆ 30 bytes (1 GB) and an equal number of 64 byte objects and 1536 byte objects, the total number of object entries is 2ˆ 30/(64+1536)=2ˆ 26/100=˜670,000.

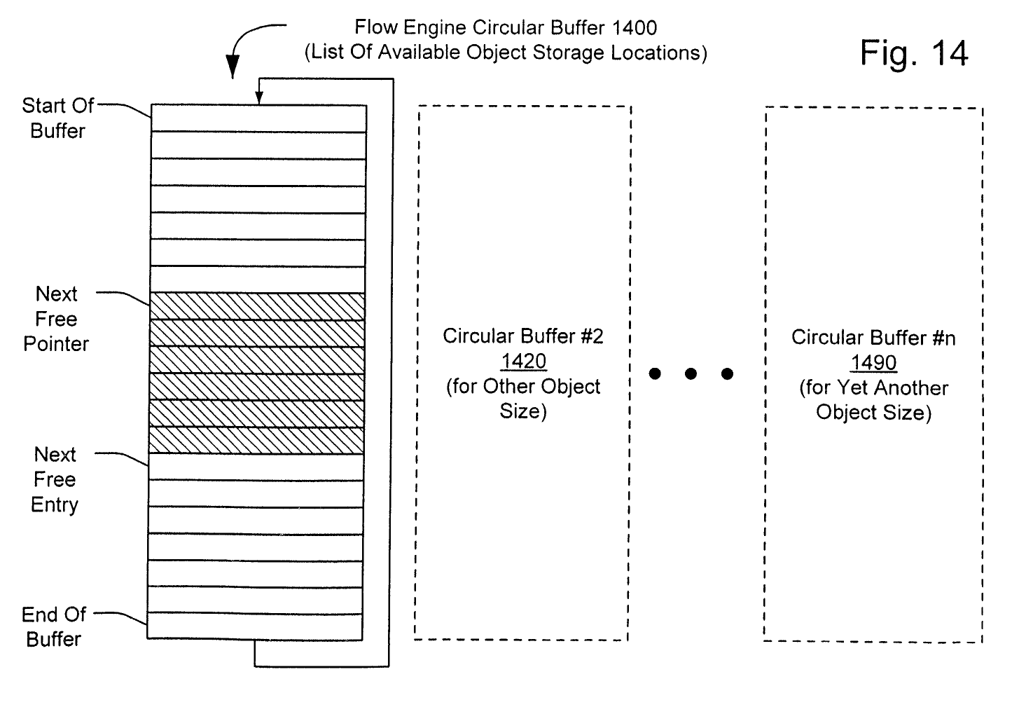

The analysis is extensible to designs with more than two object sizes, different buffer sizes and different number of object pointers. One embodiment that employs pointers is a circular buffer as shown and described below in a FIG. 14.

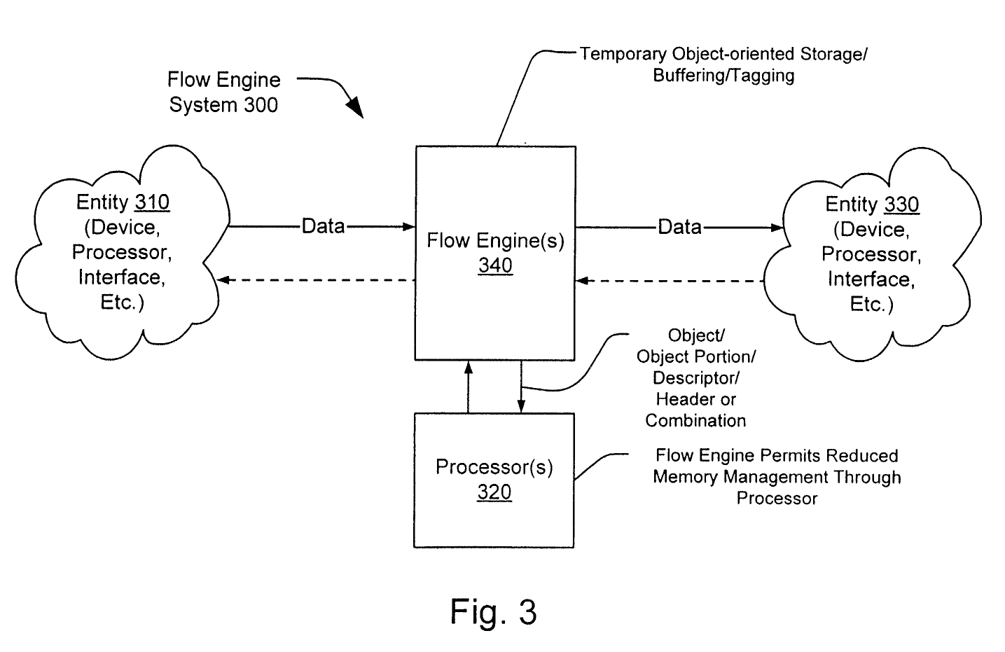

FIG. 3 is a system diagram illustrating an embodiment of a Flow Engine system 300. An entity 310 (that may be any number of entities including a device, a processor, and/or an interface) is communicatively coupled to one or more Flow Engine(s) 340. The Flow Engine(s) 340 is communicatively coupled to another entity 330. One or more Processor(s) 320 is/are communicatively coupled to the Flow Engine(s) 340. The Flow Engine(s) 340 is operable to perform one or more functions of temporary object-oriented storage, buffering, and/or tagging. A portion of the data received by the Flow Engine(s) 340 is passed to the Processor(s) 320. This portion may at times be the entirety of an object received by the Flow Engine(s) 340. In other situations, only a portion of the object is passed to the processor as enabled by the Flow Engine(s) 340. For example, this portion of the object may be a descriptor, a header and/or a combination of any of these (and any other) object portions. The Flow Engine(s) 340 permits a radical reduction in memory management that must be performed by the Processor(s) 320.

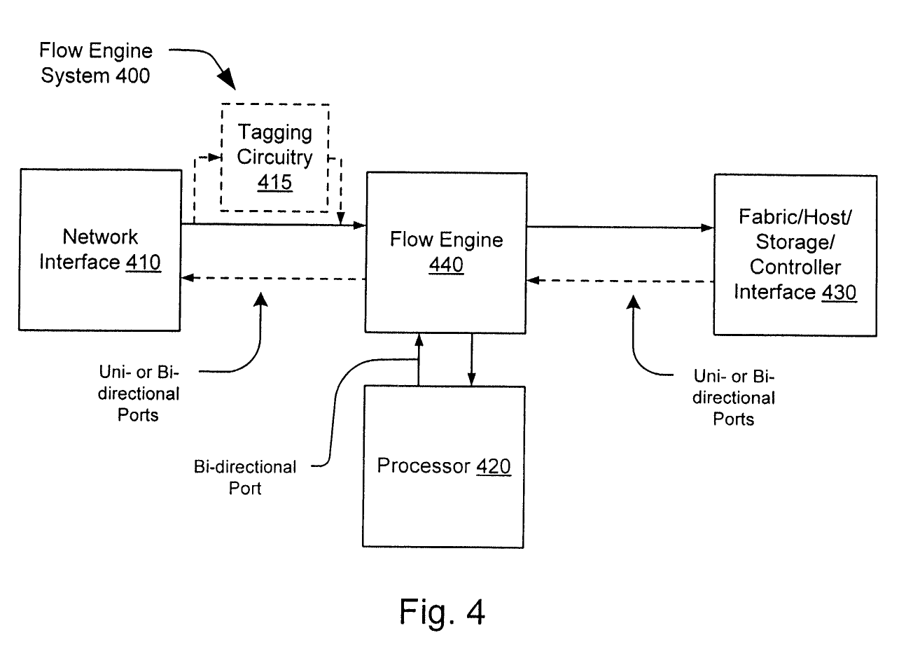

The Flow Engine as described herein provides a means to receive objects (or packets or cells or blocks) from one or more interfaces, to perform buffering and to manage those objects in memory, inspect and/or modify the content of the object, and transmit objects out through one or more interfaces. One such embodiment is shown and described below in FIG. 4. In some embodiments of the present invention, the Flow Engine resides in the data plane of the system, which includes the data streams and information flows that operate at line speed.

The Flow Engine manages the temporary storage or buffering of objects in memory. The Flow Engine is operable to assign a descriptor to uniquely identify each object stored in memory. In general, the descriptor is a pointer to the address or addresses in memory containing the object. The descriptor also includes a bit field containing the unique identification of each Flow Engine in a multi-Flow Engine system. All references to the stored object may be made using this descriptor. The descriptor is transmitted through an interface to the Controller that is a Network Processor or General Purpose Processor in certain embodiments.

Again, information transferred to a processor may include the descriptor and a portion of the object or the complete object. Information received from the network processor may include the descriptor and a portion of the object or the complete object.

From a higher level perspective, a Flow Engine system (such as the Flow Engine system 300, among other Flow Engine systems) may be described as having data path functions as well as an instruction set architecture as described below.

Data Path Functions

Ingress:

1. Header checksum generation and checking for incoming packets

2. Object manipulation:

2.a The data path does a bit field (or byte field) extraction on the object. The bit field(s) are defined by an offset from the start of the object and the number of bits to be extracted. The bit fields are programmable by the processor through the control plane interface.

2.b One or more bit fields (or byte fields) may be defined for a single object type. Multiple object types may be defined, and the object type may be selected based on the value of a tag attached to object or by examination of a fixed bit field within the object.

3. Memory error correction coding

Egress:

1. Memory error checking & correction

2. Object manipulation:

2.a. A bit field (or byte field) defined by an offset and a sequence of bits, included with the transmit command, may be applied to the packet (bits over-write the corresponding bits in the packet).

2.b. A byte sequence, stored in Flow Engine memory or supplied as part of the transmit command, may be prepended or appended to the outgoing packet.

3. Header checksum generation for outgoing packets

Instruction Set Architecture

Receive Messages (Flow Engine to Processor)

| | |
|---|---|
| REF | Reference of stored object plus extracted bit (byte) fields |
| STATUS | Configuration status |
| ACK | Acknowledgment |

Transmit Commands (Processor to Flow Engine)

| | |
|---|---|
| TRANSMIT | Transmit object at reference plus bit (byte) fields |
| STORE | Store object |
| CONFIG | Configure device |

FIG. 4 is a system diagram illustrating another embodiment of a Flow Engine system 400. Network interface circuitry 410 is communicatively coupled to a Flow Engine 440; the Flow Engine 440 is operable to receive data from the network interface circuitry 410. In this embodiment, tagging circuitry 415 is situated between the network interface circuitry 410 and the Flow Engine 440. The tagging circuitry 415 is operable to tag objects as they are transmitted from the network interface circuitry 410 to the Flow Engine 440. The tag then may be used, as mentioned above, to uniquely process each object. The Flow Engine 440 is communicatively coupled to fabric/host interface circuitry 430 and a Processor 420.

Alternatively, the tagging of data that is transmitted from the network interface 410 to the Flow Engine 440 is performed in either the network interface 410 or in the Flow Engine 440 itself.

The Flow Engine 440 is operable to perform one or more functions of temporary object-oriented storage, buffering, and/or tagging. In accordance with certain aspects of the present invention, one or more portions of the data object (including the entirety of the data object) received by the Flow Engine 440 are passed to the Processor 420. The portion may at times be the entirety of an object portion of the data that is received by the Flow Engine 440. In other situations, only a portion of the object is passed to the processor as enabled by the Flow Engine 440. For example, this portion of the object may be an object portion, a descriptor, a header and/or a combination of any of these (and any other) object portions. Again, the Flow Engine 440 permits a radical reduction is memory management that must be performed by the Processor 420. The ports that communicatively couple the network interface circuitry 410, the Flow Engine 440, and the fabric/host interface circuitry 430 within the FIG. 4 may be uni-directional or bi-directional without departing from the scope and spirit of the invention. The communicative coupling between the Flow Engine 440 and the Processor 420 is bi-directional.

The Flow Engine 440 accepts configuration and operation commands from the Processor 420 and may modify the content or format of the object or attach a label or tag to the object. The Flow Engine 440 may extract a bit field or multiple bit fields (and/or byte fields) from the object and transmit the extracted data to the Processor 420 for processing. The Flow Engine 440 may accept a bit field or bit fields from the Processor 420 for insertion in the object or to overlay on the object. Particular examples of such processing will be described in greater detail below. Those persons having skill in the art will recognize that other variations may also be performed as well without departing from the scope and spirit of the invention.

FIG. 5 is a system diagram illustrating another embodiment of a Flow Engine system 500 in a system that resembles the conventional situation where a processor is placed in the data path. FIG. 5 shows the versatility of the present invention's Flow Engine, in that, it may be implemented within architectures that seek to employ an in-stream processor. In this embodiment, a Flow Engine 540 may be used to off-load some (in fact, virtually all) of the memory management functionality that must be performed by an in-stream processor, such as a Processor 520.

Network interface circuitry 510 is communicatively coupled to a Processor 520 that is operable to receive data from network interface circuitry 510. The Processor 520 is communicatively coupled to a fabric/host interface circuitry 530 and a Flow Engine 540. The ports that communicatively couple the network interface circuitry 510, the Processor 520, and the fabric/host interface circuitry 530 within the FIG. 5 may be uni-directional or bi-directional. The communicative coupling between the Processor 520 and the Flow Engine 540 is bi-directional.

Processing elements may be in-stream or out-of-stream, connected through the data plane or control plane interface. In the data plane, the in-stream processor may be between the network interface and flow engine or between the flow engine and fabric/host interface or in both positions. Some examples are described hereinbelow.

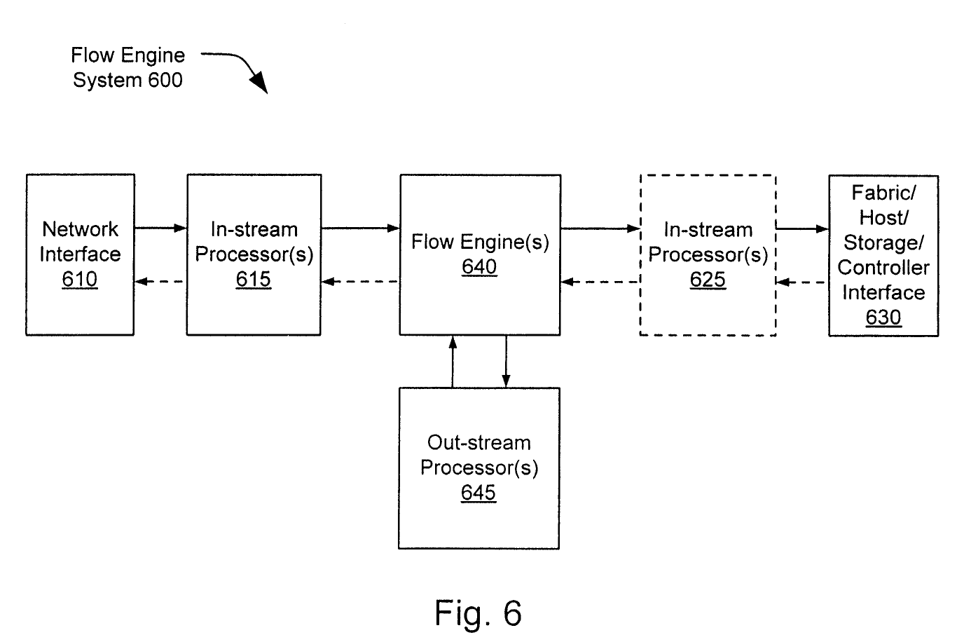

FIG. 6 is a system diagram illustrating another embodiment of a Flow Engine system 600 that may include one or more in-stream processor(s) in the data plane. In this embodiment, a network interface circuitry 610 is communicatively coupled to one or more one or more in-stream processor(s) 615 that are communicatively coupled to one or more Flow Engine(s) 640. The in-stream processor(s) 615 are located on the network side of the Flow Engine(s) 640. Alternatively, one or more in-stream processor(s) 625 are situated between one or more Flow Engine(s) 640 and a fabric/host interface 630. Moreover, one or more out-stream processor(s) 645 may also be communicatively coupled to the Flow Engine(s) 640.

Any and all of the functionality offered by a Flow Engine may be adapted to suit a variety of configurations and needs. The present invention enables operation of one or more Flow Engine(s) to provide for storing of data in the data path and to pass off controlling information to the control plane. The memory management functionality is separate from the Processor. The Flow Engines enable a system that may be designed to achieve a maximum data throughput.

In prior art systems, many designs were optimized around minimizing latency within the system. The Flow Engine provides a solution that is geared towards maximizing information throughput. In addition, the Flow Engine provides a solution that is easily scalable to include a number of Flow Engines and/or a number of Processors. For example, Multiple Flow Engines may be cascaded in a pipeline to store a larger number of objects.

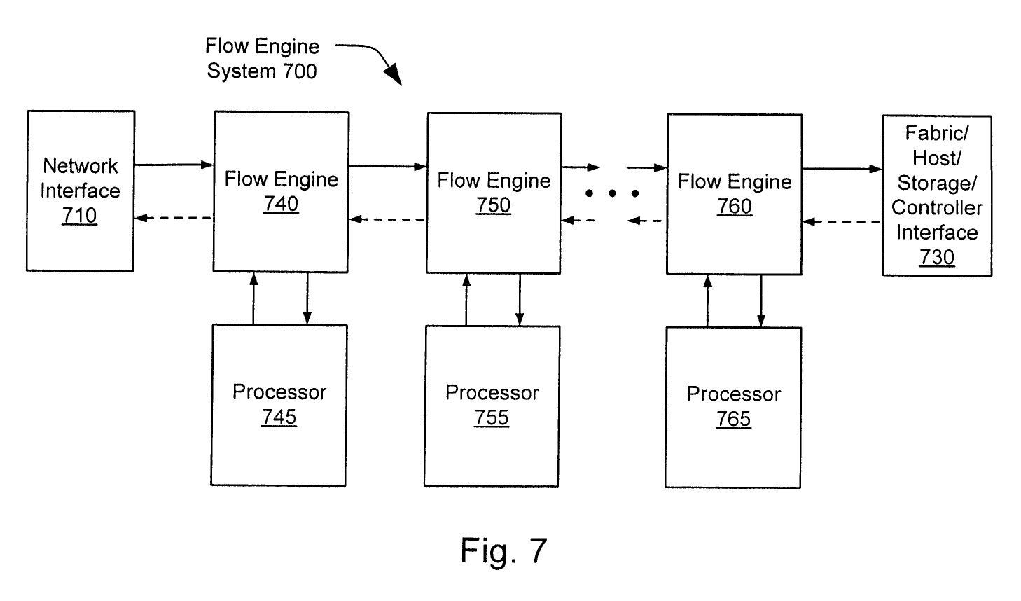

FIG. 7 is a system diagram illustrating another embodiment of a Flow Engine system 700 with scaling of memory capacity through pipelining with one Processor allocated per Flow Engine. In a pipeline configuration as shown in the FIG. 7, the data plane output of a Flow Engine 740 is connected to the data plane input of a second Flow Engine 750; the data plane output of the Flow Engine 750 is connected to the data plane input of a Flow Engine 760. This procedure may be scaled indefinitely until an adequate amount of memory is provided to an entire system.

As can be seen in FIG. 7, network interface circuitry 710 and a processor 745 are communicatively coupled to a Flow Engine 740. The Flow Engine 740 is communicatively coupled to a Flow Engine 750. A Processor 755 is communicatively coupled to the Flow Engine 750. The Flow Engine 750 is communicatively coupled to a Flow Engine 760. A Processor 765 is communicatively coupled to the Flow Engine 750. The Flow Engine 760 is communicatively coupled to fabric/host interface circuitry 730.

The ports that communicatively couple the network interface circuitry 710, the Flow Engines 740, 750, . . . and 760, and the fabric/host interface circuitry 730 within FIG. 7 may be uni-directional or bi-directional without departing from the scope and spirit of the invention. The communicative coupling between the Flow Engines 740, 750, . . . and 760 and the Processors 745, 755, . . . and 765 is bi-directional.

In embodiments that implement multiple Flow Engines, a mechanism may be implemented in each Flow Engine to determine if the input object is stored in the current Flow Engine or passed down the pipeline to a Flow Engine with available memory for storage. A status command may be transferred from a Flow Engine to a Controller (or Processor) indicating a memory overflow condition, total available (or used) memory, or upon reaching a high/low threshold (watermark) in memory.

The Flow Engine may be implemented using a field programmable gate array (FPGA), a single integrated circuit or multiple integrated circuits mounted in a multi-chip module. The Flow Engine may be implemented with internal (embedded) memory or external memory devices as well.

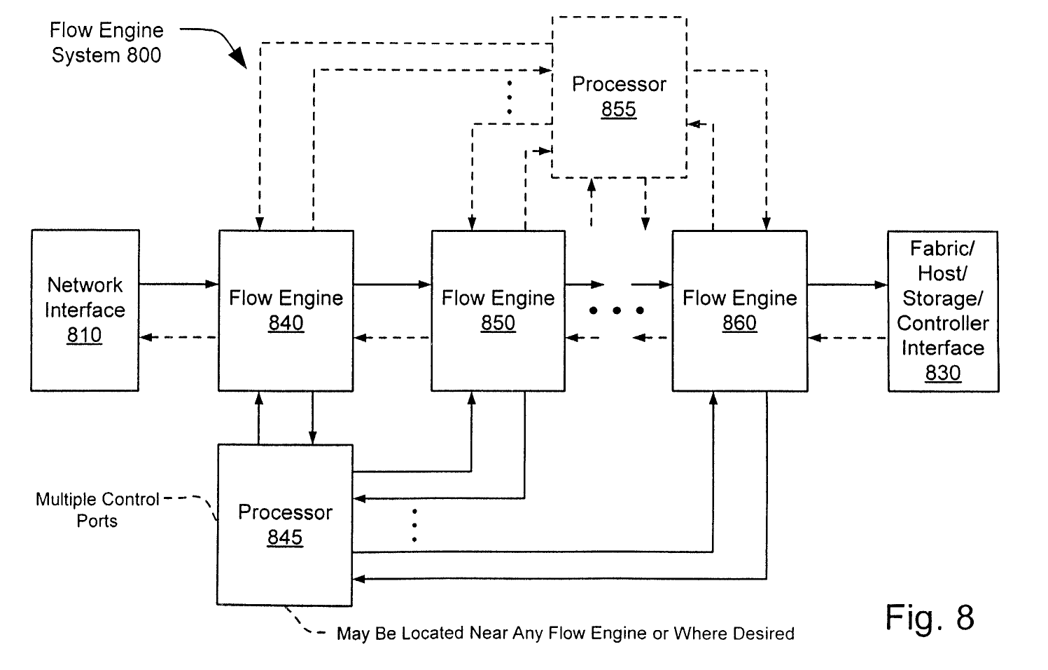

FIG. 8 illustrates another embodiment of a Flow Engine system 800 with the data plane output of a first Flow Engine connected to the data plane input of a second Flow Engine. This configuration may be extended to include any additional number of Flow Engines. For example, a single Processor 845, having multiple control ports, is communicatively coupled to a number of Flow Engines, namely, a Flow Engine 840, a Flow Engine 850, . . . , and a Flow Engine 860. Network interface circuitry 810 and a processor 845 is communicatively coupled to the Flow Engine 840. The Flow Engine 840 is communicatively coupled to the Flow Engine 850. The Processor 845 is also communicatively coupled to the Flow Engine 850. The Flow Engine 850 is communicatively coupled to the Flow Engine 860. The Processor 845 is also communicatively coupled to the Flow Engine 850. The Flow Engine 860 is communicatively coupled to a fabric/host interface circuitry 830.

The ports that communicatively couple the network interface circuitry 810, the Flow Engines 840, 850, . . . and 860, and the fabric/host interface circuitry 830 within the FIG. 8 may be uni-directional or bi-directional. The communicative coupling between the Flow Engines 840, 850, . . . and 860 and the Processors 845, 855, . . . and 865 is bi-directional. In addition, if more than one Processor is desired, a Processor 855 may also be implemented to off-load some of the processing of the Processor 845. If desired, the Processor 845 and the Processor 855 may be communicatively coupled using techniques understood by those skilled in the art. Alternatively, the Processor 845 may be implemented to service some of the Flow Engines 840, 850, . . . and 860 and the Processor 855 may be implemented to service other of the Flow Engines 840, 850, . . . and 860. The Flow Engine 845 may be located near any Flow Engine within the Flow Engine system 800 or at any locations as desired within the given application.

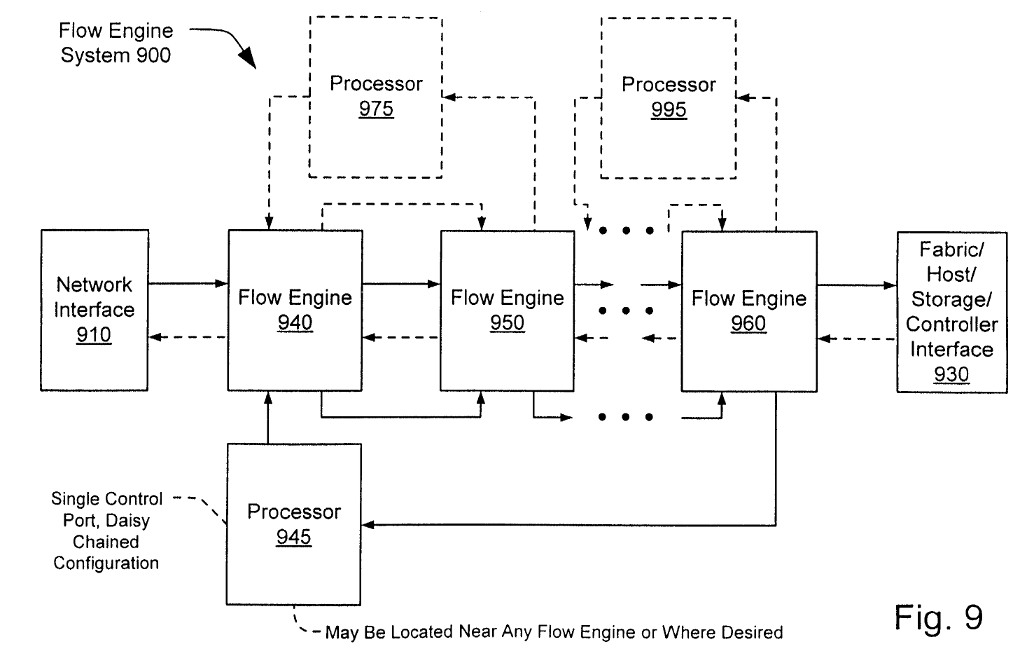

FIG. 9 is a system diagram illustrating another embodiment of the Flow Engine system of the present invention with each Flow Engine's control plane inputs and outputs connected to one or more Controllers or Processors. For example, a single Processor 945, with a single control port, is arranged in a daisy-chained configuration to a number of Flow Engines. Alternatively, a Processor 975 may be may be implemented to service some of the Flow Engines in an embodiment whereas the Processor 995 may be may be implemented to service some of the other Flow Engines.

As discussed above, a single Processor 945, having a single control port, is communicatively coupled to a number of Flow Engines in the daisy-chained configuration, namely, directly to a Flow Engine 940 and a Flow Engine 960. Network interface circuitry 910 is communicatively coupled to the Flow Engine 940. The Flow Engine 940 is communicatively coupled to a Flow Engine 950. The Flow Engine 950 is communicatively coupled to the Flow Engine 960. The Processor 945 is also communicatively coupled to the Flow Engine 960. The Flow Engine 950 is communicatively coupled to the Flow Engine 960. The Processor 945 is also communicatively coupled to the Flow Engine 960. The Flow Engine 960 is communicatively coupled to a fabric/host interface circuitry 930.

The ports that communicatively couple the network interface circuitry 910, the Flow Engines 940, 950, . . . and 960, and the fabric/host interface circuitry 930 within FIG. 9 may be uni-directional or bi-directional. The communicative coupling between the Flow Engines 940, 950, . . . and 960 and communicatively coupling to the Processors 945 is bi-directional.

In addition, in embodiments where more than one Processor is desired, a Processor 975 may also be implemented to service the Flow Engines 940 and 950 in a daisy-chained configuration. Similarly, a Processor 995 may also be implemented to service an indefinite number of Flow Engines (the Flow Engine . . . and the Flow Engine 960 in a daisy-chained configuration). The Processor 945 may be located near any Flow Engine within the Flow Engine system 900 or at any locations as desired within the given application.

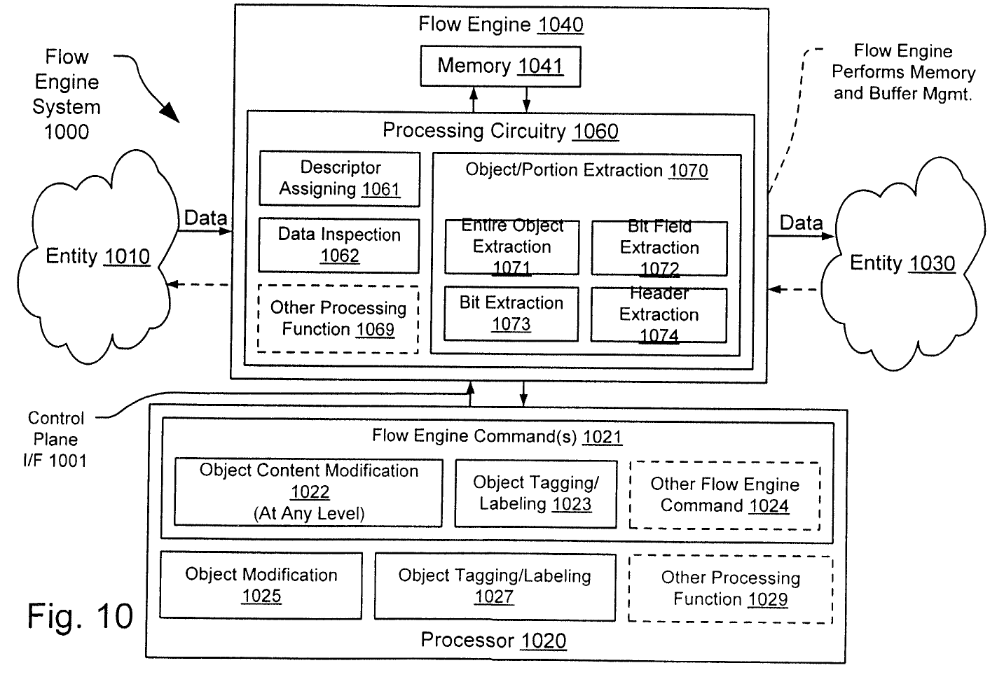

FIG. 10 is a system diagram illustrating another embodiment of a Flow Engine system 1000 with an entity 1010 communicatively coupled to a Flow Engine 1040. The Flow Engine 1040 is also communicatively coupled to an entity 1030. The communicative coupling between these devices may be uni-directional or bi-directional. However, the communicative coupling between the Flow Engine 1040 and the Processor 1020 is bi-directional. The Flow Engine 1040 is communicatively coupled to a Processor 1020. The Flow Engine 1040 includes processing circuitry 1060 that is communicatively coupled to a memory 1041. The processing circuitry 1060 is operable to perform a number of functions, including inspecting the data received by the Flow Engine 1040 (data inspection 1062) as well as assigning a descriptor to an object of the data (descriptor assigning 1061). The processing circuitry 1060 is also operable to perform object/portion extraction 1070. The object/portion extraction 1070 may be performed on an entire object (entire object extraction 1071). The object/portion extraction 1070 may alternatively be performed on a bit (byte) basis (bit extraction 1072) or a bit (byte) field basis (bit field extraction 1073). Alternatively, the extraction may be performed on the header (header extraction 1074).

In addition, the processing circuitry 1060 is operable to perform object/portion assembly, as directed by the Processor 1020. Portions of bits, bytes, bit fields, byte fields, headers, prepend bit, and append bits may all be inserted and/or attached to data that is being output from the Flow Engine 1040.

The Processor 1020 is operable to perform object modification 1025, object tagging and/or labeling 1027, and any other processing function 1029 that may be performed to a data object or to a portion of a data object. The processing may be performed at any of these levels, including byte level and bit level processing.

The Processor 1020 is operable to issue and/or perform any number of Flow Engine commands 1021 as well. The Flow Engine commands 1021 include object content modification 1022 that may be performed at any level (again, including byte level and bit level processing). In addition, the Flow Engine commands 1021 includes object tagging/labeling 1023 and any other Flow Engine command 1024.

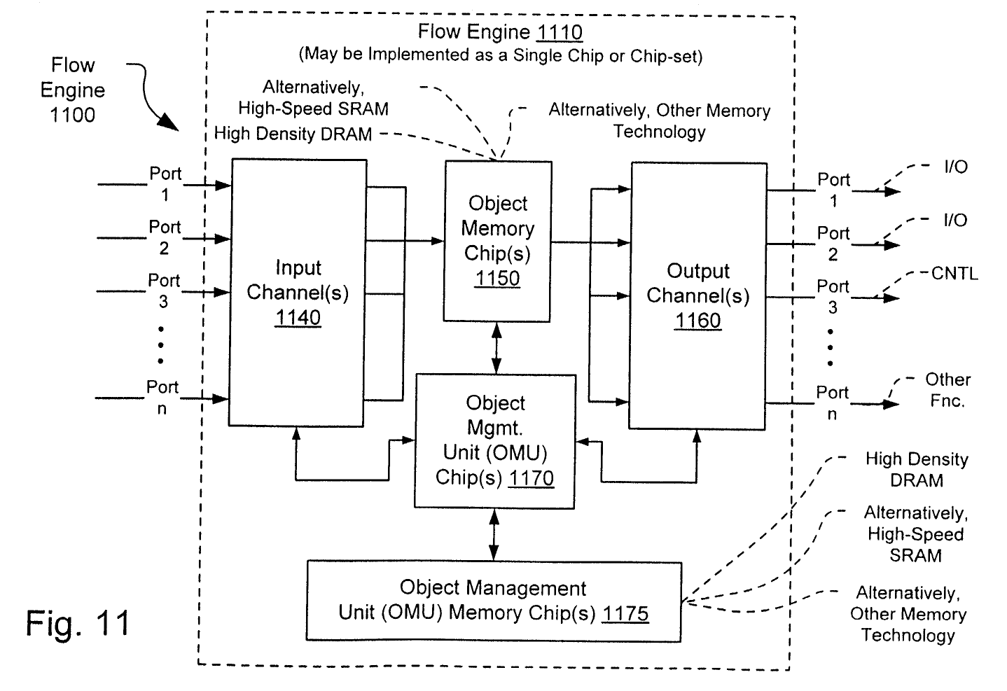

FIG. 11 is a system diagram illustrating another embodiment of a Flow Engine system 1100 that is built in accordance with various aspects of the invention. A Flow Engine 1110 may be implemented as a single chip, a chip-set or a multi-chip module as understood by those persons having skill in the art. A number of ports (port 1, port 2, port 3, . . . , and port n) are communicatively coupled to input channel(s) 1140 that are communicatively coupled to one or more object memory chip(s) 1150. The object memory chip(s) 1150 may be implemented using high-speed SRAM, high density DRAM, or other memory technology.

The object memory chip(s) 1150 are communicatively coupled to output channel(s) 1060 that provide output that may be partitioned to a number of ports (port 1, port 2, port 3, . . . , and port n). In this embodiment, the port 1 is designated as an input/output (I/O) port, the port 2 is also designated as an input/output (I/O) port, and the port 3 is designated as a control port. The port n is designated to serve some other function. Any number of other functions may be employed. There may be multiple input/output (I/O) ports and also multiple control ports as well.

The input channels 1140 and the output channels 1160 are communicatively coupled to one or more object memory unit (OMU) chip(s) 1170. The OMU chip(s) 1170 employ one or more OMU memory chip(s) 1175. Similar to the object memory chip(s) 150, the OMU memory chip(s) 1175 may be implemented high-speed SRAM, high density DRAM, or other memory technology without departing from the scope and spirit of the invention.

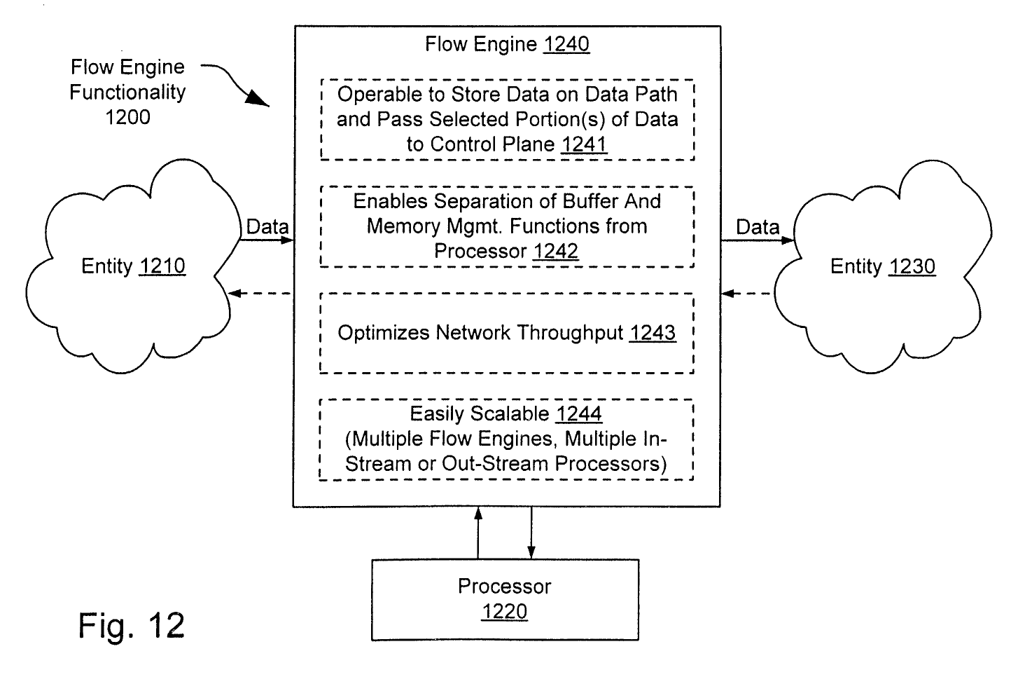

FIG. 12 is a functional block diagram illustrating an embodiment of Flow Engine functionality 1200 that is performed in accordance with the present invention. In this embodiment, Flow Engine 1240 is communicatively coupled to an entity 1210 and an entity 1230 and is also communicatively coupled to a Processor 1220. The Flow Engine 1240 is operable to store data in the data path and to pass off selected portions of data to the control plane, as shown in a functional block 1241. The selected portion of an object may be the entirety of the data in certain embodiments. In others, the selected portion of an object may be a particular bit, particular bits, a particular byte, and/or particular bytes. A header may be the selected portion in even other embodiments.

The Flow Engine 1240 also enables separation of buffer and memory management functions from the Processor, as shown in a functional block 1242. In prior art systems, the Processor was coupled in the data plane. The Flow Engine 1240 enables the removal of the Processor from this plane, thereby enabling a much larger throughput through the network.

From certain perspectives, the Flow Engine 1240 optimizes network throughput, as shown in a functional block 1243. As also described above in certain embodiments, variations of embodiments that employ a Flow Engine, e.g., the Flow Engine 1240, are also easily scalable, as shown in a functional block 1244. The scalability of the various Flow Engine designs enables for multiple Flow Engines and/or multiple in-stream and out-stream processors to be implemented. It is again noted that the Flow Engine may also be implemented into systems designed to employ a Processor in the data path. One advantage of the Flow Engine of the present invention is that it offers a degree of backward compatibility.

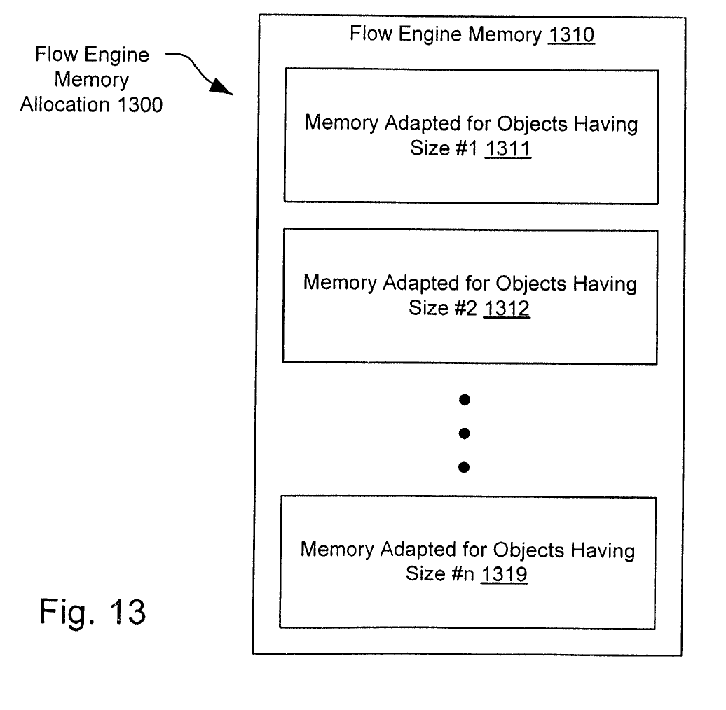

FIG. 13 is a functional block diagram illustrating an embodiment of Flow Engine memory allocation 1300. In this embodiment, a Flow Engine memory 1310 is sub-divided into an indefinite number of memory portions that are each designed and adapted primarily for particularly sized objects. For example, those persons having skill in the art will recognize that certain data objects have different sizes. These varying sizes may result from the fact that different applications simultaneously employ the functionality aspects of a Flow Engine, or it may be that a particular application or protocol employed by the Flow Engine inherently employs objects having different sizes.

In this embodiment, the Flow Engine memory 1310 includes a portion of memory adapted for objects having a size #1 1311, a portion of memory adapted for objects having a size #2 1312, . . . , and a portion of memory adapted for objects having a size #n 1319. Any number of memory portions may be adapted to meet the needs of various sized objects.

FIG. 14 is a system diagram illustrating an embodiment of a Flow Engine circular buffer 1400 that is built in accordance with certain aspects of the invention. The Flow Engine circular buffer contains a list of available packet storage locations. FIG. 14 describes a circular buffer containing object pointers (buffer memory addresses pointers). The pointers correspond to available (free) locations in the allocated partition of buffer memory for a particular size object. The pointers in the circular buffer are not required to be in any particular order.

To store an object in memory, the device reads the next available pointer and writes the object into the memory location(s) specified by the pointer. Concurrent to this operation, the circular buffer index is incremented by one to point to the next available pointer.

The pointer at which the packet is stored is sent to the Processor, along with bit (byte) fields extracted from the packet. The Processor is responsible for maintaining a list of packet pointers and processing the bit byte) field information. For example, the Processor may maintain one or more first-in first-out (FIFO) queues containing packet pointers and may implement a quality of service (QoS) algorithm based on information contained in the extracted bit (byte) field data to determine transmission ordering of objects referenced by the pointers.

At such time that the Processor determines that a specific packet be transmitted out the data port, the processor sends the object pointer to the OMU for retrieval of the object from memory along with bit (byte) fields for modification of the object contents. After the object is retrieved from memory using the reference pointer, the memory segment is returned to the pool of free object memory by writing the corresponding pointer into the next available circular buffer entry. Concurrent to this operation, the circular buffer index is incremented by one to point to the next available circular buffer entry. Alternatively, the Processor may specify that the packet is to remain in memory after transmission. This feature provides for multi-cast of a packet to multiple destinations.

It is also noted that a number of circular buffers may be employed for various object sizes. For example, a circular buffer #2 1420 may be employed for some other object size than that for the Flow Engine circular buffer 1400. In addition, a circular buffer #n 1490 may be employed for yet another object size than that for the Flow Engine circular buffer 1400.

It will be understood by those persons having skill in the art that other queuing operations may also be performed without departing from the scope and spirit of the invention. For example, a first-in, first-out (FIFO) queue approach may be employed in certain embodiments. With this option, the Flow Engine is configured as one or more first-in first-out (FIFO) queues. Each queue may be filled and emptied independently. The OMU memory contains queue data structures that specify the starting address and ending address of each queue in main memory, along with a pointer to the first entry in each queue and a pointer to the last entry in each queue. Thus, each queue data structure contains four addresses/pointers.

A queuing application is switch queuing, which may use input queues, output queues or a hybrid approach. Virtual output queuing implements a queue for each output port (N) in each input port. In addition, each output queue may support multiple priorities (M), for a total of N×M queues in each input port.

Queue Operation:

A packet is received via the input port.

2a. If the packet is tagged, the input data path forwards the tag to the OMU, which uses the tag to select a queue ID and storage address. The packet is written into the selected FIFO queue.

2b. If the packet is not tagged, the input data path extracts the specified bit (byte) field and the Flow Engine forwards the bit (byte) field to the processor. The packet is then stored in a buffer. The processor (traffic manager) examines the extracted bit (byte) field, determines the correct queue for packet storage, and returns the queue identification (ID) to the Flow Engine. The OMU selects the next entry in the selected queue and transfers the packet from the buffer to the queue specified by the processor.

2c. Alternatively, the input data path may extract selected bit (byte) fields from the packet and process these bits (bytes) to form an identifier which is passed to the OMU, which uses the identifier to select a queue ID and storage address.

The Flow Engine stores the packet in the selected queue. A message is sent to the processor indicating that a new entry has been placed in a specified queue.

As a configuration option, the Flow Engine may send a message to the processor indicating that a specific queue has reached a high or low watermark (threshold level).

The processor (traffic manager) determines the order in which to transmit the packets stored in the queues. The processor sends a transmit command with queue ID to the Flow Engine, which extracts the packet at the head of the queue and transmits it via the output port.

After transmission, the Flow Engine then sends an acknowledgement message to the processor.

In other embodiments, a memory-mapped approach may be employed for example, using direct-mapped memory. With this option, the address space of the object memory is direct-mapped to the address space of each I/O bus. Each bus address space is mapped to a Flow Engine memory address space and the mapping is configurable by the Processor.

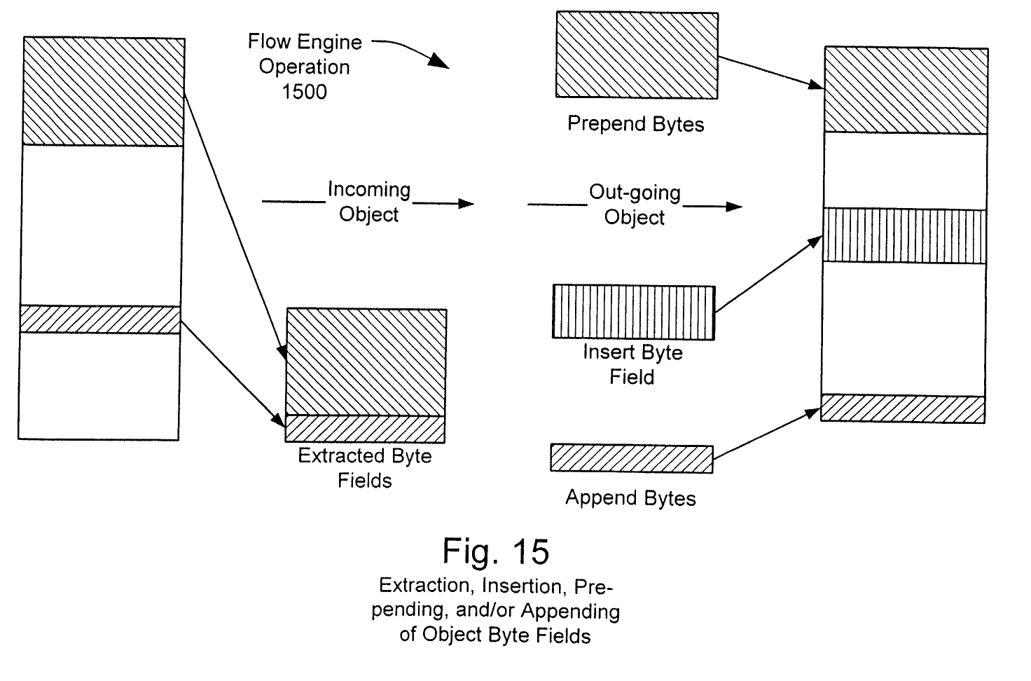

FIG. 15 is a functional block diagram illustrating an embodiment of Flow Engine operation 1500. In this embodiment, the Flow Engine provides flexible object manipulation capabilities for data plane processing of objects, which may be cells or packets or blocks or any arbitrary byte sequence. A Flow Engine can be configured to extract one or more byte fields (or bit fields) from an incoming object. The byte fields are defined by an offset from the start of the object and an extent, in units of bytes (or bits). The original object is stored in memory for later retrieval and processing, and the extracted byte field(s) are sent, along with the object location in memory, to an external controller or processor.

The present invention includes embodiments where objects of different types may be processed concurrently. Therefore, different bit (byte) field configurations may be stored in memory, one for each object type. An object tag or fixed-position byte field within the objects may be used to select a byte field configuration for a specific object.

The outgoing object may be the complete object or a concatenation of one or more byte sequences, each specified by an offset and extent, extracted from the original object or objects. Byte fields, provided by the controller as part of the transmit command or stored in memory, may be inserted in the object at a specified offset, prepended to the object, and appended to the object.

Multiple stored objects may be concatenated together to form a new object for transmission. The new object is formed by concatenating byte sequences extracted from two or more objects. Byte sequences can be prepended and appended to the concatenated object.

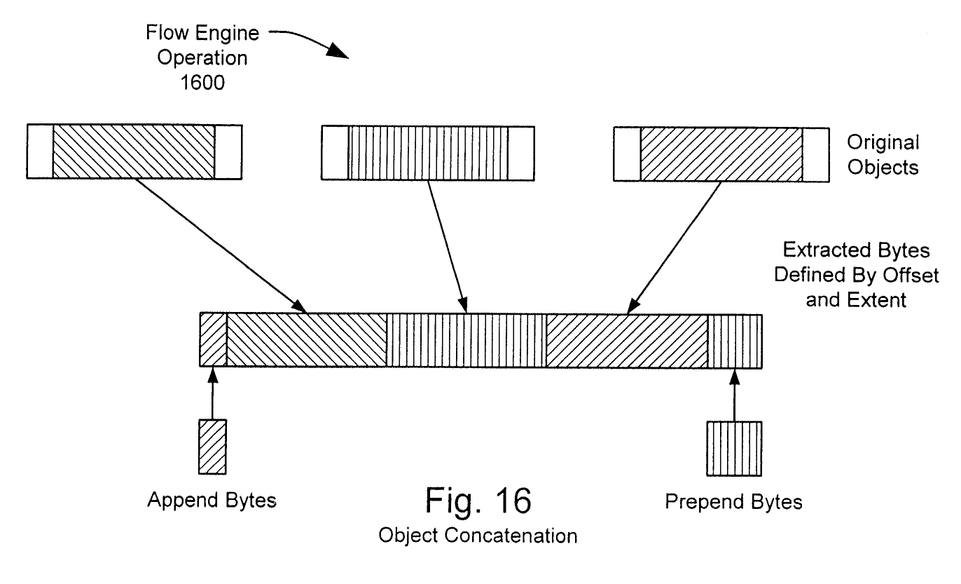

FIG. 16 is a functional block diagram illustrating another embodiment of Flow Engine operation 1600 that is performed in accordance with certain aspects of the invention. In the example shown in FIG. 16, three objects are concatenated to form a single object. An example application would be reassembly of a data file from multiple TCP/IP packets.

Those persons having skill in the art will appreciate that any number of objects may be concatenated to form a single object; alternatively, any number of objects may be concatenated in different segments to form multiple objects having the same or different sizes. For example, two or more objects can be formed by extracting byte sequences from a single object. An example application would be segmentation of a data file into multiple TCP/IP packets for transmission.

Using the present invention it is possible to manipulate objects as they enter and leave memory, using a single write and read operation to conserve memory bandwidth. Object manipulation occurs as an integral part of data movement. The present invention enables efficient processing so that data need only be moved once. As an option, operating on objects in memory with sequential object manipulation functions can be used to implement more complex functions at the expense of available memory bandwidth.

In an operation such as TCP/IP endpoint termination, objects sent to and received from the host will contain data in operating system format (e.g. Sockets API) while objects sent to and received from the network will be in TCP/IP packet format. In this application, the objects received from each interface will be of different size and format.

In an object forwarding application, the incoming and outgoing objects will generally be of the same size, unless there is change in network maximum transfer unit (MTU) size, in which case the objects will be fragmented into smaller objects, or a label is attached to the object.

TCP requires that an acknowledgement be sent for each received segment. Therefore, some objects (acknowledgements) may originate in the controller or be assembled in the output data path using byte or bit fields from objects stored in memory (e.g. source and destination address).

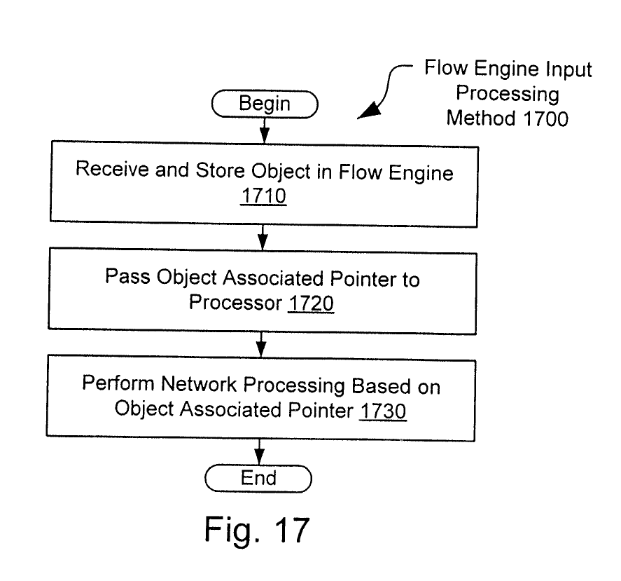

FIG. 17 is a functional block diagram illustrating an embodiment of a Flow Engine input processing method 1700. In a block 1710, an object is received and stored in a Flow Engine. In block 1720, an object-associated pointer is passed to a Processor. In block 1730, processing is performed within a Processor based on the object-associated pointer. Any of the various embodiments of Flow Engines that operate cooperatively with Processors may be employed to perform the Flow Engine input processing method 1700.

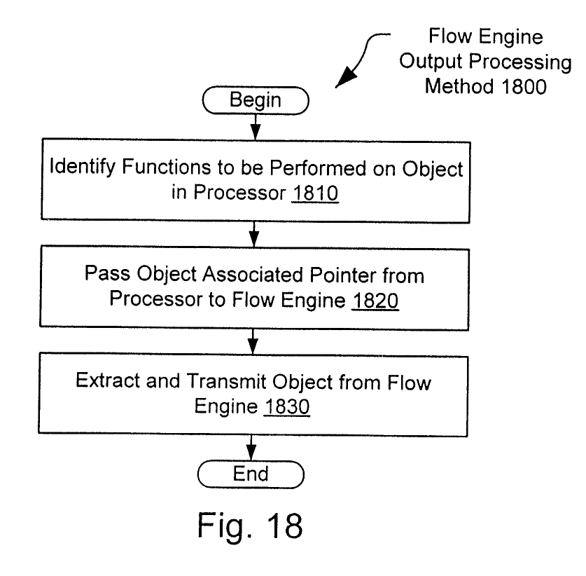

FIG. 18 is a functional block diagram illustrating an embodiment of a Flow Engine output processing method 1800. In a block 1810, functions that are to be performed on an object are identified in a Processor. In block 1820, an object-associated pointer is passed from a Processor to a Flow Engine. In block 1830, the object is extracted and transmitted from the Flow Engine. Again, any of the various embodiments of Flow Engines that operate cooperatively with Processors may be employed to perform the Flow Engine output processing method 1800.

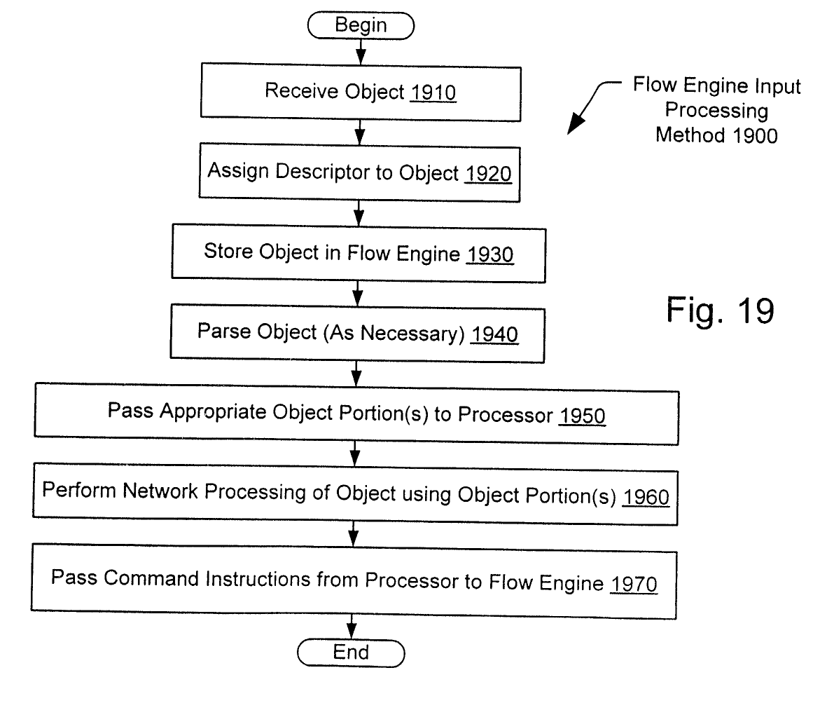

FIG. 19 is a functional block diagram illustrating another embodiment of a Flow Engine input processing method that is performed in accordance with certain aspects of the invention. In a block 1910, an object is received. In block 1920, a descriptor is assigned to the object that is received in the block 1910. Then, in block 1930, the object is stored in a Flow Engine. When necessary, the object may be parsed as shown in a block 1940. The parsing may be on a byte basis, a bit basis, and/or on a header or a footer basis.

In a block 1950, the appropriate object portions are passed to a Processor. The entirety of the object may be passed to the Processor in certain embodiments. Alternatively, a number of bits, bytes, or byte fields may be passed to the Processor. Then, in block 1960, processing may be performed on the object using the object portions that are passed to the Processor in the block 1950. Afterwards, one or more command instructions are passed from the Processor to the Flow Engine in a block 1970. Again, any of the various embodiments of Flow Engines that operate cooperatively with Processors may be employed to perform the Flow Engine input processing method 1900.

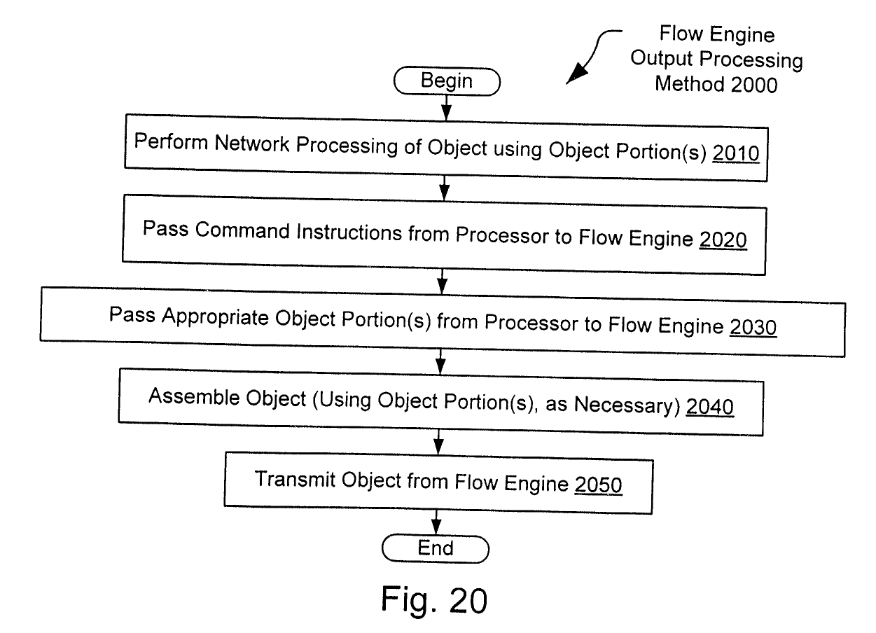

FIG. 20 is a functional block diagram illustrating another embodiment of a Flow Engine output processing method 2000. In a block 2010, processing is performed on an object using certain object portions. In a block 2020, the command instructions are passed from a Processor to a Flow Engine. In a block 2030, the appropriate object portions are passed from the Processor to the Flow Engine. As necessary, an object is assembled using the object portions in a block 2040. Then, in a block 2050, the object is transmitted out of the Flow Engine. Again, any of the various embodiments of Flow Engines that operate cooperatively with Processors may be employed to perform the Flow Engine output processing method 2000.

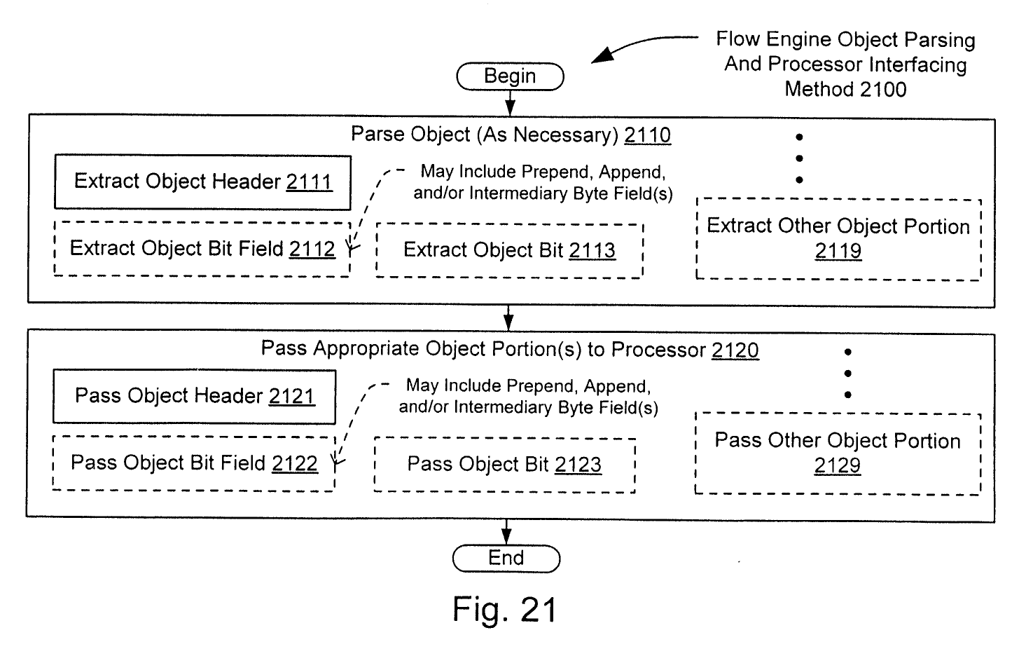

FIG. 21 is a functional block diagram illustrating another embodiment of a Flow Engine object parsing and Processor interfacing method 2100. An object is parsed, as necessary, in a block 2110. The parsing of the object may take a number of forms including extracting of an object header 2111, extracting of an object bit field 2112, extracting of an object bit 2113, . . . , and extracting of any other object portion 2119. As an example, the extracting of the object bit field 2112 may include processing that is performed on byte fields that are prepend byte fields, append byte fields and/or intermediary byte fields. Similarly prepend, append, and/or intermediary object portions may be used during various extraction processes as well.

Then, in block 2120, the appropriate objects are passed to a Processor. The passing of the object portions to the Processor may take a number of forms including passing of an object header 2121, passing of an object bit field 2122, passing of an object bit 2123, . . . , and passing of any other object portion 2129. As an example, the passing of the object bit field 2122 from the Flow Engine to the Processor may include passing of object portions that are byte fields such as prepend byte fields, append byte fields and/or intermediary byte fields. Similarly prepend, append, and/or intermediary object portions may be used during various passing processes as well. Any of the various embodiments of Flow Engines that operate cooperatively with Processors may be employed to perform the Flow Engine input processing method 2100.

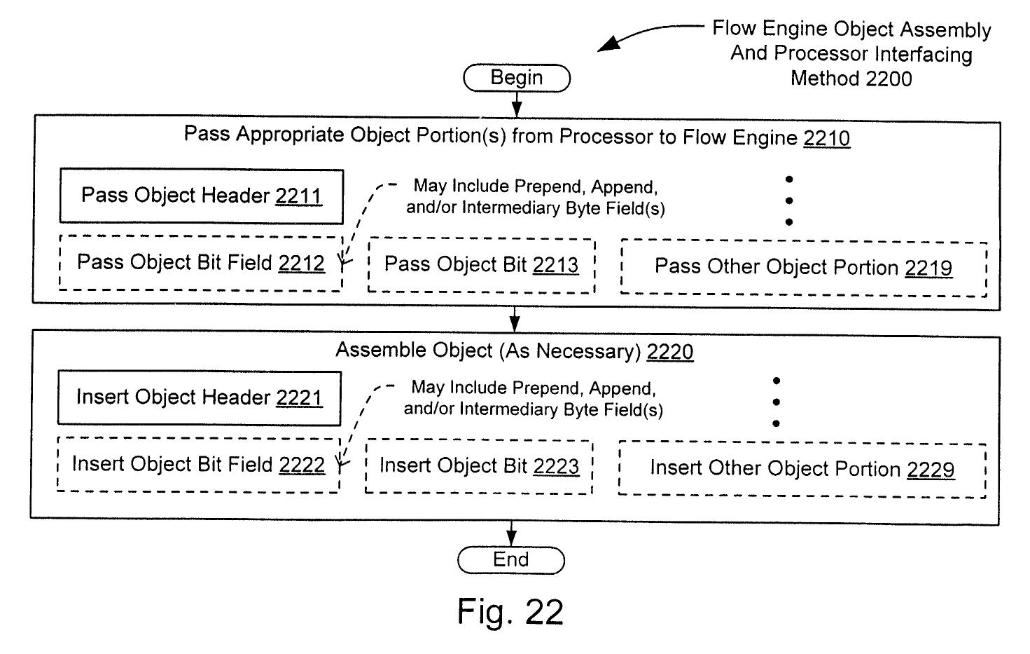

FIG. 22 is a functional block diagram illustrating another embodiment of a Flow Engine object assembly and Processor interfacing method 2200. In a block 2210, the appropriate objects are passed from a Processor to a Flow Engine. The passing of the object portions to the Flow Engine may take a number of forms including passing of an object header 2211, passing of an object bit field 2212, passing of an object bit 2213, . . . , and passing of any other object portion 2219. As an example, the passing of the object bit field 2212 from the Processor to the Flow Engine may include passing of object portions that are byte fields such as prepend byte fields, append byte fields and/or intermediary byte fields. Similarly prepend, append, and/or intermediary object portions may be used during various passing processes as well.

An object may also be assembled, as necessary, in a block 2220. The assembly of the object may take a number of forms including inserting of an object header 2221, inserting of an object bit field 2222, inserting of an object bit 2223, . . . , and inserting of any other object portion 2229. As an example, the inserting of the object bit field 2222 may include processing that is performed on byte fields that are prepend byte fields, append byte fields and/or intermediary byte fields. Similarly prepend, append, and/or intermediary object portions may be used during various assembly processes as well. Again, any of the various embodiments of Flow Engines that operate cooperatively with Processors may be employed to perform the Flow Engine output processing method 2200.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A flow engine system, comprising:
a flow engine; and
a processor that is communicatively coupled to the flow engine; and
wherein the flow engine is operable to receive a first object via a first interface and to transmit a second object via a second interface;
the flow engine transmits a descriptor, that is associated with the first object, to the processor; and
the processor provides a command to the flow engine, the command comprising at least one of an object modification command and an object transmission command.

2. The flow engine system of claim 1, wherein the flow engine is operable to extract a portion of the first object, the portion comprising at least one of a bit, a bit field, a byte, and a byte field.

3. The flow engine system of claim 2, wherein the portion is passed to the processor for processing to generate a processed portion.

4. The flow engine system of claim 3, wherein the processed portion is passed back to the flow engine.

5. The flow engine system of claim 4, wherein the processed portion is inserted into the first object in place of the extracted portion; and
wherein the second object comprises the first object and the inserted processed portion.

6. The flow engine system of claim 1, wherein the first object and the second object are the same object.

7. The flow engine system of claim 1, wherein the processor is aligned in an in-stream configuration with respect to the flow engine.

8. The flow engine system of claim 1, wherein the processor is aligned in an out-stream configuration with respect to the flow engine.

9. The flow engine system of claim 1, further comprising at least one additional flow engine that is communicatively coupled to the flow engine.

10. The flow engine system of claim 9, further comprising at least one additional processor that is communicatively coupled to the at least one additional flow engine.

11. The flow engine system of claim 9, wherein the at least one additional flow engine is also communicatively coupled to the processor.

12. The flow engine system of claim 11, wherein the flow engine and the at least one additional flow engine are communicatively coupled to the processor in a daisy-chained configuration.

13. The flow engine system of claim 1, wherein the flow engine assigns the descriptor to the first object when the flow engine received the first object.

14. The flow engine system of claim 1, wherein the flow engine comprises a memory;
the first object is stored in the memory; and
the descriptor comprises a pointer to an address associated with a location in the memory where the first object is stored.

15. The flow engine system of claim 14, wherein the memory comprises at least two memory divisions;
one memory division of the at least two memory divisions is adapted for objects having a first size; and
one memory division of the at least two memory divisions is adapted for objects having a second size.

16. The flow engine system of claim 1, wherein the flow engine comprises a plurality of ports; and
at least one of the ports within the plurality of ports comprises a control interface port for the communicatively coupling between the flow engine and the processor.

17. The flow engine system of claim 1, wherein the command that is provided to the flow engine from the processor comprises information concerning a destination where the second object is to be transmitted from the flow engine via the second interface.

18. The flow engine system of claim 1, wherein at least one of the first interface and the second interface is communicatively coupled to at least one of a network interface circuitry and a fabric/host interface circuitry.

19. The flow engine system of claim 1, further comprising a tagging circuitry, in signal communication with the flow engine, that tags the first object before the first object is received via the first interface; and
wherein the first object's tag indicates an object type of the first object.

20. The flow engine system of claim 1, wherein the flow engine performs data inspection of the first object.

21. A flow engine system, comprising:
a flow engine that is communicatively coupled to a first interface and a second interface; and
a processor that is communicatively coupled to the flow engine; and
wherein the flow engine assigns a descriptor to an object when the flow engine receives the object from at least one of the first interface and the second interface;
the flow engine is operable to parse the object into at least one object portion;
the flow engine transmits at least one of the descriptors and the at least one object portion to the processor;
the processor is operable to identify at least one of processing operation and a transmission operation for the object, based on the descriptor; and
the processor provides a command to the flow engine, the command comprising at least one of an object modification command and an object transmission command.

22. The flow engine system of claim 21, wherein the processor performs data processing on the at least one object portion to generate a processed object portion; and
the processor transmits the processed object portion back to the flow engine.

23. The flow engine system of claim 22, wherein the processor inserts at least one additional object portion into the at least one object portion to generate the processed object portion.

24. The flow engine system of claim 23, wherein the at least one additional object portion comprises at least one of a prepend byte and an append byte.

25. The flow engine system of claim 21, wherein the object modification command transmitted to the flow engine by the processor commands the flow engine to perform data processing on the at least one object portion to generate a processed object portion.

26. The flow engine system of claim 25, wherein the flow engine inserts at least one additional object portion into the at least one object portion to generate the processed object portion.

27. The flow engine system of claim 26, wherein the at least one additional object portion comprises at least one of a prepend byte and an append byte.

28. The flow engine system of claim 21, wherein the flow engine transmits the entire object to the processor.

29. The flow engine system of claim 21, wherein the command that is provided to the flow engine from the processor comprises information concerning a destination where the second object is to be transmitted from the flow engine via the second interface.

30. The flow engine system of claim 21, further comprising at least one additional flow engine that is communicatively coupled to the flow engine.

31. The flow engine system of claim 30, further comprising at least one additional processor that is communicatively coupled to the at least one additional flow engine.

32. The flow engine system of claim 30, wherein the at least one additional flow engine is also communicatively coupled to the processor.

33. The flow engine system of claim 32, wherein the flow engine and the at least one additional flow engine are communicatively coupled to the processor in a daisy-chained configuration.

34. The flow engine system of claim 21, wherein the flow engine comprises a memory;
the object is stored in the memory; and
the descriptor comprises a pointer to an address associated with a location in the memory where the object is stored.

35. The flow engine system of claim 34, wherein the memory comprises at least two memory divisions;
one memory division of the at least two memory divisions is adapted for objects having a first size; and
one memory division of the at least two memory divisions is adapted for objects having a second size.

36. A flow engine processing method, the method comprising:
receiving an object in a flow engine;
assigning a descriptor to the object using the flow engine;
storing the object in the flow engine;
passing at least a portion of the object from the flow engine to a processor, the processor is communicatively coupled to the flow engine; and
passing a command instruction from the processor to the flow engine concerning processing of the at least one portion of the object.

37. The method of claim 36, further comprising parsing the object in the flow engine to generate the at least one object portion.

38. The method of claim 37, wherein the at least one object portion comprises at least one of a bit, a bit field, a byte, and a byte field.

39. The method of claim 37, further comprising passing the entirety of the object to the processor.

40. The method of claim 36, further comprising retrieving an object from memory, the memory being located in the flow engine.

41. The method of claim 36, further comprising modifying the object using the at least one object portion in the flow engine.

42. The method of claim 36, further comprising modifying the object using the at least one object portion in the processor.

43. The method of claim 36, further comprising transmitting the object from the flow engine via an interface of the flow engine.

44. The method of claim 36, further comprising inserting at least one additional object portion into the object.

45. The method of claim 44, wherein the at least one additional object portion comprises at least one of a prepend byte and an append byte.

46. The method of claim 44, wherein the at least one additional object portion is inserted into the object by the processor.

47. The method of claim 44, wherein the at least one additional object portion is inserted into the object by the flow engine.

48. The method of claim 36, further comprising modifying the at least one object portion in the processor to generate a modified object portion.

49. The method of claim 48, further comprising transmitting the modified object portion from the processor to the flow engine.

50. A flow engine processing method, the method comprising:
passing a command instruction from a processor to a flow engine concerning processing of at least one object portion, the processor is communicatively coupled to the flow engine;
retrieving an object from memory, the memory being located in the flow engine;
modifying the object using the at least one object portion in the flow engine; and
transmitting the object from the flow engine via an interface of the flow engine.

51. The method of claim 50, further comprising receiving at least one additional object in the flow engine;
assigning a descriptor to the at least one additional object using the flow engine;
storing the object in the flow engine; and
passing at least a portion of the at least one additional object from the flow engine to the processor, the processor is communicatively coupled to the flow engine.

52. The method of claim 51, further comprising passing the entirety of the object to the processor.

53. The method of claim 50, further comprising parsing the object in the flow engine to generate the at least one object portion.

54. The method of claim 50, further comprising inserting at least one additional object portion into the object.

55. The method of claim 54, wherein the at least one additional object portion comprises at least one of a prepend byte and an append byte.
